(19) United States
(12) Patent Application Publication
(10) Pub. No.: US 2012/0303519 A1
(43) Pub. Date: Nov. 29, 2012

(54) USER INPUT OF CONSUMER SPENDING TRANSACTION DATA FOR SAVINGS AND DONATIONS PROGRAMS

(76) Inventor: Bertram V. Burke, Sarasota, FL (US)

(21) Appl. No.: 13/479,221

(22) Filed: May 23, 2012

Related U.S. Application Data
(60) Provisional application No. 61/489,247, filed on May 23, 2011.

(51) Int. Cl. G06Q 40/00

(52) U.S. Cl. 705/39

(57) ABSTRACT

A method for accumulating funds in a target account is provided. A server receives transaction data from a user via a communications network, wherein the transaction data includes at least a unique identifier for the user and a spending amount. Next, the server accesses a record associated with the user and reads at least a savings determinant, source account data and target account data from the record. Then, the server calculates a savings amount based on the savings determinant and the spending amount and increments a current value based on the savings amount. Finally, the server transmits, over the communications network, a message to a provider of the source account, wherein the message includes a request to transfer the current value from the source account to the target account.

### CROSS-REFERENCE TO RELATED APPLICATIONS

This utility patent application claims priority to provisional application No. 61/489,247 entitled “Consumer Controlled Rounding, Savings, Budgeting, Purchasing, and Social Networking,” filed May 23, 2011. The subject matter of provisional application No. 61/489,247 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to financial industries and, more specifically, to processes for accumulating credits for savings or donations programs over telecommunications networks.

### BACKGROUND

Various methods and programs for automatically accumulating funds or credits in a savings or charitable account have been disclosed. In one example, U.S. Pat. Nos. 7,502,758 and 7,571,849, disclose methods and systems that allow a consumer to pre-define how he or she desires to save or donate using a particular account and thereafter any consumer spending transaction, such as using a debit card at a point of sale terminal, writing a check, or using a credit card, the consumer performs using the aforementioned account is subject to the predefined savings or donations scheme. This technique eliminates the need for the consumer to enter savings data at each spending transaction. The method, however, applies the predefined savings or donations scheme to all spending transactions the consumer performs using the particular account, which may not be desirable. Further, the method requires that the entity providing the savings or donations accounts also has access to the spending transaction data. If the savings or donations accounts provider is different and separate from the entity that possesses the spending transaction data, the account provider must request the spending transaction data. This may be problematic if the holder of the spending transaction data will not provide the data, presents obstacles to gaining access to the data or charges a fee for the data.

Therefore, a need exists for improvements over the prior art, and more particularly for methods and systems that provide more flexibility when accumulating funds or credits in a savings or charitable account.

### SUMMARY

A method and system that allows for user input of spending transaction data in an automatic process for accumulating funds or credits in a savings or charitable account is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for accumulating funds in a target account is provided that solves the above-described problem that requires the entity providing the savings or donations accounts having access to the consumer's spending transaction data. A server receives transaction data from a user via a communications network, wherein the transaction data includes at least a unique identifier for the user and a spending amount. Next, the server accesses a record associated with the user based on the unique identifier for the user and reads at least a savings determinant, source account data and target account data from the record associated with the user. Then, the server calculates a savings amount based on the savings determinant and the spending amount and increments a current value based on the savings amount, wherein the current value is associated with the user. Finally, the server transmits, over the communications network, a message to a provider of a source account defined by the source account data, wherein the message includes a request to transfer the current value from the source account to a target account defined by the target account data.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports the automatic accumulation of funds or credits in a savings or charitable account, according to an example embodiment;

FIG. 2 is a diagram showing the data flow of an automatic funds accumulation process, according to an example embodiment;

FIG. 3 is a flow chart of a method for providing automatic accumulation of funds or credits in a savings or charitable account, according to an example embodiment;

FIG. 4 is a flow chart of a method for setting up the process of providing automatic accumulation of funds or credits in a savings or charitable account, according to an example embodiment;

FIG. 5 is a flow chart of a method for calculating savings amounts, according to an example embodiment; and

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Disclosed methods provide for user input of consumer spending transaction data for processes that provide automatic accumulation of funds or credits in a savings or charitable account. The systems and methods of the present invention eliminate the requirement that a consumer enter data pertaining to the amount he or she desires to save or donate at each consumer spending transaction, thereby saving time for the consumer. Further, the systems and methods of the present invention improve over the prior art by selectively applying a predefined savings or donations scheme to certain spending transactions input by a user. Lastly, the systems and methods of the present invention improve over the prior art by eliminating the requirement that the entity providing the savings or donations accounts also houses the spending transaction data, which is typically housed by the provider of the source account used for the spending transaction. The present invention allows for the consumer to directly enter spending transaction data into the system, thereby removing the necessity of the system to request the spending transaction data from the source account provider.

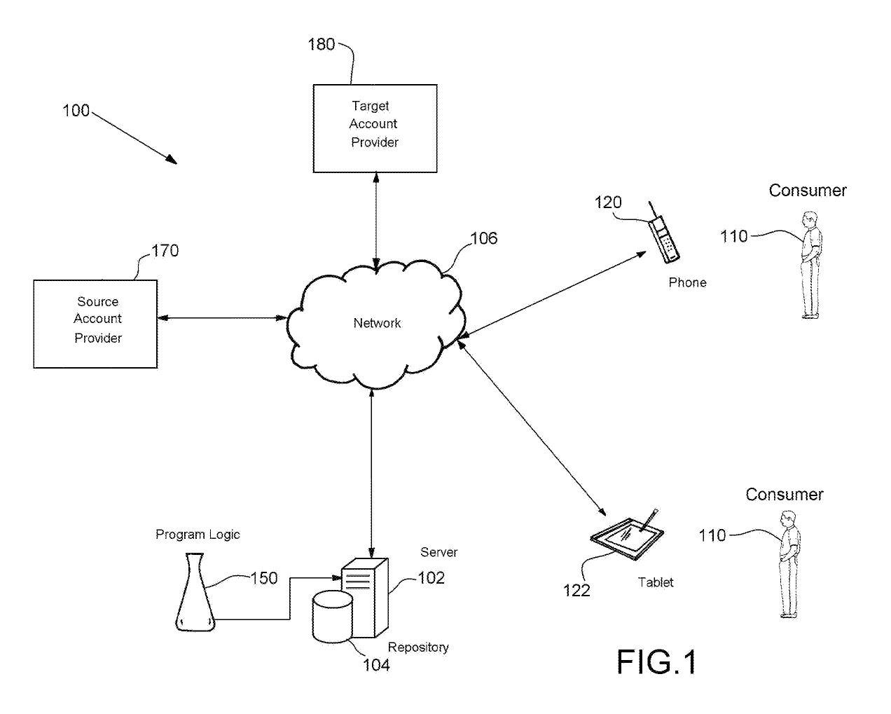

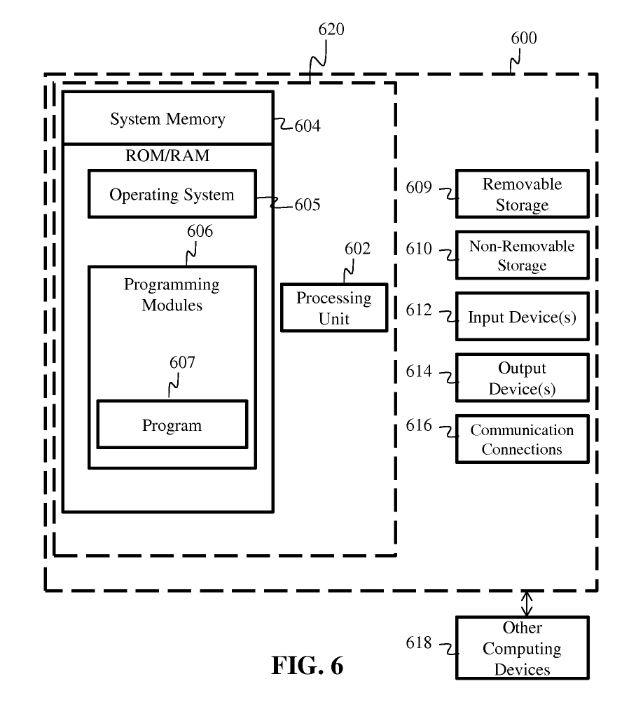

FIG. 1 is a block diagram of an operating environment 100 that supports the automatic accumulation of funds or credits in a savings or charitable account, according to an example embodiment. The environment 100 may comprise multiple client computers 120, 122 and a server 102 communicating via a communications network 106. Each of the client computers 120, 122 and server 102 may be connected either wirelessly or in a wired or fiber optic form to the communications network 106. Client computers 120, 122 and server 102 may each comprise a computing device 600, described below in greater detail with respect to FIG. 6. FIG. 1 shows that client computers 120, 122 may comprise mobile computing devices such as cellular telephones, smart phones or tablet computers, or other computing devices such as a desktop computer, laptop, game console, for example. Communications network 102 may be a packet switched network, such as the Internet, or any local area network, wide area network, enterprise private network, cellular network, phone network, mobile communications network, or any combination of the above.

Environment 100 may be used when multiple consumers or customers 110, 112 engage in consumer spending transactions and desire to enter spending transaction data into server 102. A consumer spending transaction comprises the purchase of a good or service using cash, a check, a credit card, a debit card, a gift card, store credit, or the like. Spending transaction data, or transaction data, comprises any of the data that is used or transferred during a consumer spending transaction, such as: the price paid for a good or service purchased, the individual price paid for any good or service purchased in a group of goods or services, any taxes paid and how the taxes were applied to each good or service purchased in a group, any savings or discounts that were provided to the consumer and how the savings were applied to each good or service purchased in a group, the date, the time, the location, the account number that was used, the name of the consumer, any account data related to the account that was used to purchase the goods or services. The term spending amount refers to the price of one or more goods or services purchased (without or without applicable taxes, tariffs, discounts, setoffs, etc.), or the individual price of any good or service purchased in a group of goods or services.

An account is a record that logs transactions between a consumer and his account provider, usually a bank or other liquidity provider, and the resulting position of the consumer with the account provider. An account may hold various pieces of information, the most significant being the current balance of funds, credits or money of the consumer. An account may refer to a deposit account that holds funds, credits or money that the provider owes to the consumer or may be a debit or loan account that defines funds, credits or money that the consumer owes to the provider. Conventional savings accounts, checking accounts and retirement accounts are examples of deposit accounts. Credit card accounts are examples of loan accounts. As used in this patent application, the term savings account refers to any deposit account and the term charitable or donations account refers to any deposit account that is provided by or for the benefit of a charitable organization.

Account data refers to information that identifies a particular account, such as an account number, the name of the account holder, a routing number, a SWIFT code, the name of the account provider, the address of the account provider, any numbers or codes printed on a physical card used by the consumer (such as a plastic debit card or credit card), any passwords, PIN numbers or other credentials associated with the account, etc.

Source account provider 170 refers to an account provider, such as a bank, financial institution, merchant, liquidity provider, etc., that provides an account to the consumers 110, 112. A source account refers to an account from which funds, credits or money originate in the methods 200 and 300 defined below. Target account provider 170 provides a target account to consumers 110, 112 to which funds, credits or money are transferred in the methods 200 and 300 defined below. Each client computer 120, 122 may connect directly to server 102 so as to enter spending transaction data into server 102, as defined in method 200.

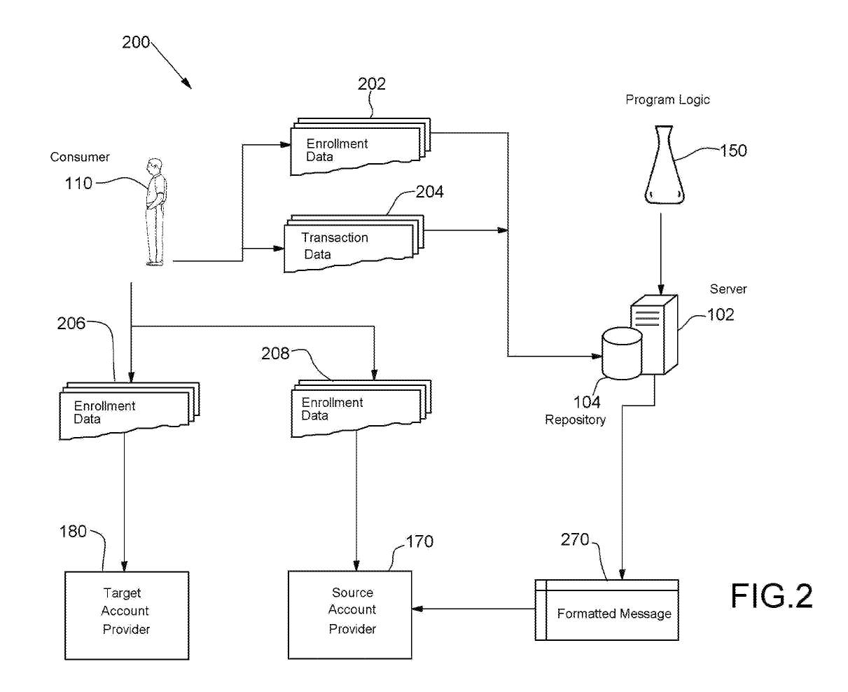

FIG. 1 further shows that server 102 includes a database or repository 104, which may be a relational database comprising a Structured Query Language (SQL) database stored in a SQL server. Client computers 120, 122 may also each include their own database. The repository 104 serves data from a database, which is a repository for data used by server 102 and the client computers during the course of operation of the invention. The database 104 may include a consumer record for each consumer 110, 112. A consumer record may include: contact/identifying information for a consumer, spending transaction data of the consumer, a unique identifier for the consumer, demographic data for the consumer (such as age, sex, income data, race, color, marital status, etc.), source account(s) data, target account(s) data, any other account data, social security number, tax identification number, and savings scheme information, which is defined in created detail below with reference to FIG. 2. A consumer record may also include a current value or balance that represents an amount of funds, credits or money that has been saved using the present invention and that is scheduled to be transferred from the source account to the target account.

FIG. 1 shows an embodiment of the present invention wherein networked computing devices 120, 122 interact with server 102 and repository 104 over the network 106. Server 102 includes a software engine that delivers applications, data, program code and other information to networked computing devices 120, 122. The software engine of server 102 may perform other processes such as transferring multimedia data in a stream of packets that are interpreted and rendered by a software application as the packets arrive. It should be noted that although FIG. 1 shows only two networked computing devices 120, 122, the system of the present invention supports any number of networked computing devices connected via network 106.

Server 102 includes program logic 150 comprising computer source code, scripting language code or interpreted language code that is compiled to produce executable file or computer instructions that perform various functions of the present invention. In another embodiment, program logic 150 may be distributed among more than one of server 102, computers 120, 122, or any combination of the above. In yet another embodiment, program logic 150 may comprise program module 607 in FIG. 6.

Note that although server 102 is shown as a single and independent entity, in one embodiment of the present invention, the functions of server 102 may be integrated with another entity, such as one of the client computers or one or more of the account providers 170, 180. Further, server 102 and its functionality, according to a preferred embodiment of the present invention, can be realized in a centralized fashion in one computer system or in a distributed fashion wherein different elements are spread across several interconnected computer systems.

FIG. 2 is a diagram showing the data flow 200 of an automatic funds accumulation process, according to an example embodiment. FIG. 2 depicts the transfer of data from an example consumer 110 to target account provider 180, source account provider 170 and server 102. FIG. 2 shows that consumer 110 may provide enrollment data 206 to target account provider 180. The enrollment data 206 is used by the target account provider to establish a target account, such as a savings account, with the target account provider 180. Thus, enrollment data 206 may include any of the data that may be entered into a consumer record, as defined above. Similarly, the enrollment data 208 provided to the source account provider 170 is used by the source account provider to establish a source account, such as a checking account, with the source account provider 170. Thus, enrollment data 208 may also include any of the data that may be entered into a consumer record. Note the present invention supports the creation of more than one source account with more than one source account providers and the creation of more than one target accounts with more than one target account providers.

FIG. 2 further shows that consumer 110 may provide enrollment data 202 to server 102. The enrollment data 202 is used by the server 102 to establish a user account with server 102 and to define and store savings scheme information that defines how the consumer 110 intends to save funds, credits or money using the system of the present invention. Thus, enrollment data 202 may include any of the data that may be entered into a consumer record, as defined above, as well as any of the enrollment data 206 and 208. Further, enrollment data 202 may include account data for one or more target accounts and one or more source accounts.

In one embodiment of the present invention, with regard to enrollment data 202, the program logic 150 of server 102 stores the account data, or a portion thereof, pertaining to one or more target accounts and/or one or more source accounts on a third party site via network 106.

As explained above, savings scheme information defines how the consumer 110 intends to save funds, credits or money using the system of the present invention. Savings scheme information may include a budget definition wherein the consumer 110 pre-defines a budget, which may comprise a list that defines how much money or funds should be spent on each category for a given time period, such as daily, weekly or monthly. An example of a budget may be a monthly budget that defines $500 for rent (i.e., a category), $200 for food, $100 for clothing and $100 for utilities.

Savings scheme information may also include a time period that defines how often funds are transferred from one or more source accounts to one or more target accounts, such as daily, weekly or monthly. Also, savings scheme information may include details about which source accounts should be used and how much to use each one, as well as details about which target accounts should be used and how much to use each one. For example, savings scheme information may define that a certain percentage of the current value shall be transferred from one or more source accounts to a particular target account.

Savings scheme information may include definitions for savings schemes. A first type of savings scheme involves rounding. Each time a consumer effectuates a consumer spending transaction, the spending amount is rounded up or increased by a small amount, referred to as a savings amount, up to a predefined amount. The savings amount, for example, may comprise an amount that rounds the spending amount up to the nearest whole dollar amount, up to the nearest whole dollar amount plus an additional value, up to a percentage of the spending amount, up to a percentage of the spending amount plus an additional value, etc. In another example, the savings amount is simply an amount that is added to a spending amount. The savings amount is added to the current value in a consumer record of consumer 110, as defined in more detail below. The current value is the amount of funds, money or credit that is allocated for transferring to one or more target accounts.

A second type of savings scheme involves transferring an amount saved in a source account. If the source account of consumer 110 shows that the consumer has spent less than budgeted in a predefined budget for one or more categories at the end of a predefined time period, the difference between the actual expenditure and the predefined budget is allocated for transferring to one or more target accounts. For example, if consumer 110 has budgeted $200 for food each month but the source account of consumer 110 shows that the consumer has spent $100 for food at the end of a month, then $100 is allocated for transferring to one or more target accounts. The difference between the actual expenditure and the predefined budget is added to the current value in the consumer record of consumer 110, as defined in more detail below.

A third type of savings scheme involves transferring an amount that has been discounted. If a consumer spending transaction shows that the merchant or seller has discounted the spending amount by a certain amount, then the discounted amount is allocated for transferring to one or more target accounts. For example, if consumer 110 buys a meal for $5 but the merchant has discounted the meal by $3, then $3 is allocated for transferring to one or more target accounts. The discounted amount is added to the current value in the consumer record of consumer 110.

A fourth type of savings scheme involves transferring a given amount each predefined time period. If a consumer 110 defines that each month he desires to save $100, for example, then the given amount of $100 is allocated for transferring to one or more target accounts each month. The given amount is added to the current value in the consumer record of consumer 110.

A fifth type of savings scheme involves the consumer defining savings goals and the program logic 150 of server 120 defining a savings amount that is applied at some predefined interval. Based on a monetary amount and a deadline defined by the consumer, the program logic 150 of server 120 extrapolates a savings amount that must be saved each day, week or month in order to achieve the goal defined by the consumer. For example, if consumer 110 desires to purchase a big screen television for $1,500 in seven months, the program logic 150 of server 120 schedules $214.29 to be allocated for transferring to one or more target accounts monthly, or, alternatively, $47.62 allocated for transferring to one or more target accounts weekly. The allocated amounts are added to the current value in the consumer record of consumer 110 and transferred from one or more source accounts to one or more target accounts at predefined time periods.

A sixth type of savings scheme involves the user defining a specific amount of funds at any point in time to be allocated instantly for transferring to one or more target accounts. The allocated amount is added to the current value in the consumer record of consumer 110 and transferred from one or more source accounts to one or more target accounts at predefined time periods.

A savings determinant is defined as any data that indicates which of the savings schemes defined above is used for a particular spending transaction. The savings determinant is stored in the consumer record associated with each consumer. In another embodiment, each category may have a separate savings determinant associated with it. In this embodiment, the consumer record associated with each consumer contains a list that shows which savings determinant is associated with each category.

In another embodiment, machine readable instructions may be used to define savings schemes as defined above. The machine readable instructions may be stored in the consumer record associated with each consumer. In another embodiment, each category may have a separate set of machine readable instructions associated with it. In this embodiment, the consumer record associated with each consumer contains a list that shows which set of machine readable instructions is associated with each category. The machine readable instructions define an algorithm that, when executed, calculate a savings amount based on spending transaction data.

FIG. 2 further shows that subsequent to the enrollment of the target account with target account provider 180, the enrollment of the source account with source account provider 170 and the enrollment of the user account with server 102, the consumer 110 may directly provide spending transaction data 204 to the server 102. Recall that spending transaction data comprises any of the data that is used or transferred during a consumer spending transaction. In one embodiment, the data 204 provided to the server 102 may also include any of the savings scheme information defined above.

The consumer 110 may provide the spending transaction data 204 to the server 104 using his client computer 120 in text format (such as via email or SMS text), via audio provided by voice, by interacting with an interface that allows the consumer to input the spending transaction data, or any combination of the above. In one embodiment of the present invention, the consumer 110 provides a voice command to his computer 120, which performs a voice recognition routine and converts the voice command into text data. In another embodiment of the present invention, the consumer 110 provides a voice command to his computer 120, which sends the voice command as audio to a third party via the network 106, wherein the third party performs a voice recognition routine and converts the voice command into text data and subsequently sends the text data back to the computer 120 via network 106. Subsequently, the resulting text data 204 is transmitted from the computer 120 to the server 102 via network 106.

Finally, FIG. 2 further shows that server 102 provides formatted message 270 to the source account provider 170. Based on the spending transaction data 204 provided by the consumer 110, and the savings scheme information previously entered by the consumer 110, the program logic 150 of server 102 (in a process defined in more detail in methods 300 and 500 below) calculates a current value that must be transferred from one or more source accounts to one or more target accounts. Consequently, the program logic 150 of server 102 generates a message 270 that includes a request to one or more source account providers to transfer the current value, or a portion thereof, from one or more source accounts to one or more target accounts. The message 270 may comprise an electronic funds transfer (EFT) message. The message 270 may include a variety of information, such as any account data defined above or any data that may be included in a consumer record, also defined above.

In one embodiment, message 270 may be formatted to comply with any financial network transaction standardized format, such as ISO 8583, ISO 9362, financial EDI standard (ANSI 820), etc. Consequently, the program logic 150 of server 102 transmits the message 270 to one or more source account provider 170 via the communications network 106. After receiving the message 270, the one or more source account provider 170 effectuates the transfer of the current value, or a portion thereof, from one or more source accounts to one or more target accounts.

In an embodiment of the present invention, where the program logic 150 of server 102 has previously stored the account data, or a portion thereof, pertaining to one or more target accounts and/or one or more source accounts on a third party site, the program logic 150 of server 102 proceeds as follows. The program logic 150 of server 102 generates a message 270 that includes a request for one or more source account providers to transfer the current value, or a portion thereof, from one or more source accounts to one or more target accounts. Subsequently, the program logic 150 of server 102 transmits the message 270 to the third party site, which possesses the account data for the one or more source accounts and the one or more target accounts. Then, the third party site generates a message that includes a request to one or more source account providers to transfer the current value, or a portion thereof, from one or more source accounts to one or more target accounts. The message generated by the third party site includes the account data that was stored on the third party site.

Note that the enrollment of the target account with target account provider 180, the enrollment of the source account with source account provider 170, and the enrollment of the user account with server 102 may be accomplished by the consumer 110 via his client computer, via voice interaction over a telephone, in person or by proxy.

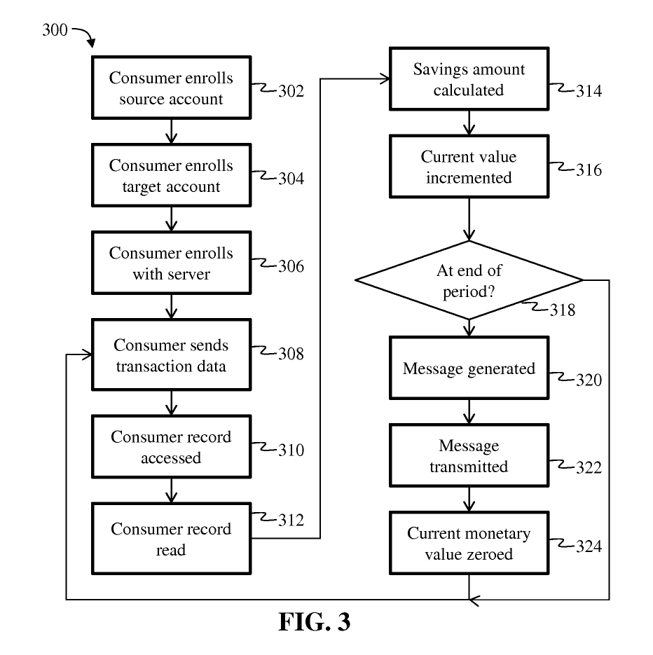

FIG. 3 is a flow chart of a method 300 for providing automatic accumulation of funds or credits in a savings or charitable account, according to an example embodiment. FIG. 3 depicts the actions of an example consumer 110 and the server 102 in the process of providing automatic accumulation of funds or credits in a savings or charitable account.

Method 300 may begin at stage 302 wherein the consumer 110 enrolls a source account with source account provider 170 by providing enrollment data 208, as defined in FIG. 2 above. Next, in stage 304 the consumer 110 enrolls a target account with target account provider 180 by providing enrollment data 206, as defined in FIG. 2 above. Then, in stage 306 the consumer 110 enrolls a user account with server 102 by providing enrollment data 202, as defined in FIG. 2 above. In stage 308, the consumer 110 effectuates a consumer spending transaction and subsequently sends spending transaction data 204 to the server 102 via the network 106, as defined in FIG. 2 above.

Next, in stage 310, the program logic 150 of server 102 accesses the user record associated with the consumer 110. The program logic 150 of server 102 may the user record associated with the consumer 110 using a unique identifier embedded in the spending transaction data 204. Then, in stage 312, the program logic 150 of server 102 reads the user record associated with the consumer 110. Particularly, the program logic 150 of server 102 may read a savings determinant from the user record, as well as target account data and source account data. In another embodiment, the program logic 150 of server 102 may also read machine readable instructions for calculating a savings amount from the user record.

In yet another embodiment, based on a category provided by the consumer in data 204, the program logic 150 of server 102 may determine which savings determinant or machine readable instructions for calculating a savings amount corresponds to the category provided by the consumer and consequently reads the appropriate savings determinant or machine readable instructions from the user record. In yet another embodiment, the program logic 150 of server 102 may also read data defining a time period from the user record.

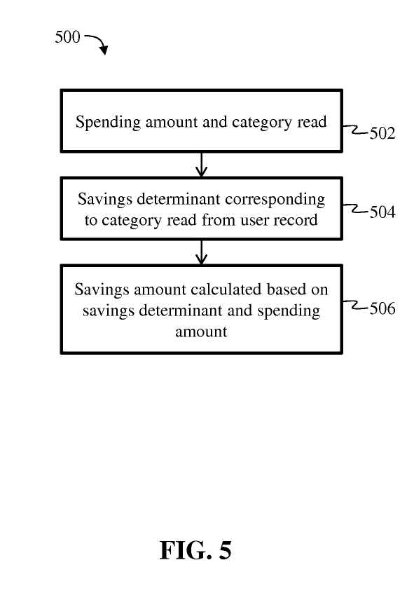

In stage 314, based on the data that was read in step 312, the program logic 150 of server 102 calculates a savings amount based on the savings determinant in the consumer record and the spending amount provide by the consumer 110 in transaction data 204 (as defined in greater detail below with reference to FIG. 5). In step 316, the current value in the consumer record of consumer 110 is incremented to include the savings amount. In step 318, the program logic 150 of server 102 determines whether the end of a current time period has been reached, as a time period has been defined in the consumer record of consumer 110. If the end of a current time period has not been reached, then control flows back to stage 308. If the end of a current time period has been reached, then in stage 320, the program logic 150 of server 102 generates a message 270 that includes a request to the source account provider to transfer the current value, or portion thereof, from the source account to the target account. In step 322, the program logic 150 of server 102 transmits the message 270 to the source account provider 170 via the communications network 106. In step 324, the current value in the consumer record of consumer 110 is reduced by the amount that was transferred to reflect the transfer from the source account to the target account. In one embodiment, the current value in the consumer record of consumer 110 is reduced to zero to reflect the transfer of the entire current value from the source account to the target account.

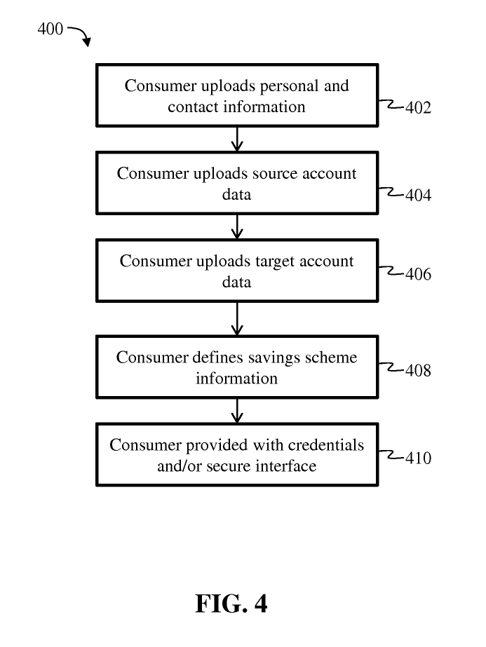

FIG. 4 is a flow chart of a method 400 for setting up the process of providing automatic accumulation of funds or credits in a savings or charitable account, according to an example embodiment. Method 400 depicts the process by which the consumer 110 sets up or initializes a user account with server 102. Method 400 starts with stage 402 wherein the user enters personal and contact information into server 102, such as any of the enrollment data 202 defined above. The data entered by the consumer 110 in stage 402 is stored in one or more consumer records associated with the consumer 110 in database 104. Next, in stages 404 and 406, the consumer 110 uploads source account data and target account data, respectively, into the database 104 of server 102, which data is stored in the consumer record(s) associated with the consumer 110. In stage 408, the consumer 110 uploads savings scheme information into the database 104 of server 102, which information is stored in the consumer record(s) of consumer 110.

Finally, in stage 410, the program logic 150 of server 102 may provide the consumer 110 with secure credentials that allows the consumer to log securely into server 102 in the future. Alternatively, the program logic 150 of server 102 may provide the consumer 110 with a secure interface that allows the consumer to interface securely with server 102 using, for example, an encrypted connection.

FIG. 5 is a flow chart of a method 500 for calculating a savings amount, according to an example embodiment. Note that method 500 provides greater detail about the processes 312-314 of FIG. 3. Method 500 may be implemented using a computing device 600 as described in more detail below with respect to FIG. 6. An example implementation of the stages of method 500 will be described in greater detail below.

In stage 502, the program logic 150 of server 102 reads the spending amount and, optionally, the category, provided by the consumer 110 in step 308 of method 300. By way of example, the spending amount may be given as $1.50. In stage 504, the program logic 150 of server 102 reads the savings determinant from the consumer record of consumer 110. In the given example, the savings determinant indicates rounding to the next whole dollar amount. In another embodiment, the program logic 150 of server 102 reads, from the consumer record of consumer 110, the savings determinant that corresponds to the category provided by the consumer 110. Recall the savings determinant is defined as any data that indicates which of the savings schemes defined above is used for a particular spending transaction. Finally, in step 506, the program logic 150 of server 102 calculates the savings amount based on the savings determinant and the spending amount. In the ongoing example, the spending amount of $1.50 is rounded to the nearest whole dollar amount of $2.00, such that the savings amount is calculated to be $0.50.

In an alternative embodiment of the present invention, in stage 504, the program logic 150 of server 102 reads the machine readable instructions from the consumer record of consumer 110. In another embodiment, the program logic 150 of server 102 reads, from the consumer record of consumer 110, the machine readable instructions that correspond to the category provided by the consumer 110. The machine readable instructions define an algorithm that, when executed, calculate a savings amount based on spending transaction data. In stage 506, the program logic 150 of server 102 executes the machine readable instructions so as to calculate the savings amount based on the spending amount.

FIG. 6 is a block diagram of a system including an example computing device 600 and other computing devices. Consistent with the embodiments described herein, the aforementioned actions performed by client computers 120, 122, by server 102 and the providers 170, 180 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 300, 400 and 500 as described above. Methods 300, 400 and 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600's operation. In one embodiment, programming modules 606 may include, for example, a program module 607 for executing the actions of program logic 150. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of method 300's, method 400's or method 500's stages as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for accumulating funds in a target account, comprising:
receiving transaction data from a user via a communications network, wherein the transaction data includes at least a unique identifier for the user and a spending amount;
accessing a record associated with the user based on the unique identifier for the user;
reading at least a savings determinant, source account data and target account data from the record associated with the user;
calculating a savings amount based on the savings determinant and the spending amount;
incrementing a current value based on the savings amount, wherein the current value is associated with the user; and
transmitting, over the communications network, a message to a provider of a source account defined by the source account data, wherein the message includes a request to transfer the current value from the source account to a target account defined by the target account data.

2. The method of claim 1, wherein the step of receiving transaction data comprises receiving a text-based message from a mobile computing device of the user.

3. The method of claim 1, wherein the transaction data further includes a category for the spending amount.

4. The method of claim 1, wherein the step of reading at least a savings determinant further comprises reading, from the record associated with the user, machine readable instructions for calculating a savings amount.

5. The method of claim 4, wherein the step of calculating a savings amount further comprises executing the machine readable instructions for calculating the savings amount based on the savings determinant and the spending amount.

6. The method of claim 1, wherein the step of reading at least a savings determinant further comprises reading, from the record associated with the user, at least a savings determinant corresponding to the category of the spending amount.

7. The method of claim 1, wherein the step of incrementing a current value further comprises incrementing a current value based on the savings amount, wherein the current value is stored in the record associated with the user.

8. The method of claim 1, wherein the source account and the target account each comprise any one of a bank account, a gift card account, an investment account, a credit card account, a store credit account and a charity account.

9. The method of claim 8, wherein the target account comprises two or more separate accounts.

10. The method of claim 1, wherein the step of transmitting a message comprises transmitting, over the communications network, a message to a provider of a source account defined by the source account data, wherein the message includes a request to transfer a portion of the current value from the source account to a target account defined by the target account data; and
wherein the step of reducing the current value comprises reducing the current value by the portion of the current value to reflect transfer of funds from the source account to the target account.

11. A computer system, connected to a communications network, for accumulating funds in a target account, the system comprising:
a receiver configured for receiving transaction data from a user via a communications network, wherein the transaction data includes at least a unique identifier for the user and a spending amount;
a memory storage;
a network connection device; and
a processing unit coupled to the memory storage, wherein the processing unit is operative to:
access in a connected database a record associated with the user based on the unique identifier for the user;
reading from the record at least source account data, target account data and machine readable instructions for calculating a savings amount;
executing the machine readable instructions for calculating a savings amount based on the spending amount;
incrementing a current value based on the savings amount, wherein the current value is associated with the user;
generating a formatted message requesting transfer of the current value of funds from a source account defined by the source account data to the target account defined by the target account data, wherein the message is formatted in a financial network transaction standardized format; and
transmitting the message over the communications network to a provider of the source account.

12. The computer system of claim 11, wherein the step of receiving transaction data comprises receiving a text-based message from a mobile computing device of the user.

13. The computer system of claim 11, wherein the transaction data further includes a category for the spending amount.

14. The computer system of claim 11, wherein the step of reading from the record further comprises reading, from the record associated with the user, machine readable instructions for calculating a savings amount, wherein the machine readable instructions correspond to the category of the spending amount.

15. The computer system of claim 11, wherein the step of incrementing a current value further comprises incrementing a current value based on the savings amount, wherein the current value is stored in the record associated with the user.

16. The computer system of claim 11, wherein the source account and the target account each comprise any one of a bank account, a gift card account, an investment account, a credit card account, a store credit account and a charity account.

17. The computer system of claim 16, wherein the target account comprises two or more separate accounts.

18. The computer system of claim 11, wherein the step of transmitting a message comprises transmitting, over the communications network, a message to a provider of a source account defined by the source account data, wherein the message includes a request to transfer a portion of the current value from the source account to a target account defined by the target account data; and
wherein the step of reducing the current value comprises reducing the current value by the portion of the current value to reflect transfer of funds from the source account to the target account.

19. A computer program product for accumulating funds in a target account, the computer program product comprising at least one computer readable storage medium having one or more computer readable program code portions stored therein, said computer readable program code portions comprising:
a first executable portion for receiving transaction data from a user via a communications network, wherein the transaction data includes at least a unique identifier for the user and a spending amount;
a second executable portion for accessing a record associated with the user based on the unique identifier for the user;
a third executable portion for reading at least a savings determinant, source account data and target account data from the record associated with the user;
a fourth executable portion for calculating a savings amount based on the savings determinant and the spending amount;
a fifth executable portion for incrementing a current value based on the savings amount, wherein the current value is associated with the user; and
a sixth executable portion for transmitting, over the communications network, a message to a provider of a source account defined by the source account data, wherein the message includes a request to transfer the current value from the source account to a target account defined by the target account data.
